(19) United States
(12) Patent Application Publication
(10) Pub. No.: US 2009/0317778 A1
(43) Pub. Date: Dec. 24, 2009

(54) Public Library System for Providing Reading-Together at Two Remote Locations of a Selected Children Literature Item

(76) Inventor: Dror Oberman, Bet Shemesh (IL)

Correspondence Address: VENABLE LLP, P.O. BOX 34385, WASHINGTON, DC, 20043-9998, US

(21) Appl. No.: 12/445,546

(22) PCT Filed: Oct. 10, 2007
(86) PCT No.: PCT/IL07/01222

§ 371 Date: Apr. 14, 2009

(30) Foreign Application Priority Data
Oct. 16, 2006 (IL) 178653

(51) Int. Cl. G09B 5/00; G09B 17/00

(52) U.S. Cl. 434/169; 434/178

(57) ABSTRACT

The invention relates to an electronic public library system for providing reading together of an electronic children literature item at two remote computers, which comprises: (a) an adult computer and a child computer that are located remote one from the other, and are connected to the Internet; (b) two mouse pointing devices, one at each of said computers; (c) a camera and microphone at each of said computers for producing an adult live video channel and child live video channel from each of said adult and child computers respectively; and (d) a library server which comprises: (i) storage for storing a collection of children literature items for selection; (ii) a user interface for enabling access, and selection of an item from a first of said adult or child computers; (iii) item processing unit for (I) establishing communication with said two computers; (II) receiving the adult and child video channels from said adult and child computers respectively; (III) activating the selected children literature item; (IV) receiving mouse locations from each of said two computers from a synchronization unit; (V) sending synchronized images simultaneously to both of said adult and child computers, wherein the images sent to each of said two computers comprise the same literature item image at a first screen portion, mouse indicators of said two computers distinguished one from the other by shape, and for each party, a live video display of the other party positioned at a second screen portion; and (iv) a synchronization unit for receiving control instructions over the literature item from each of said computers, and mouse location from each of said

computers, effecting the control over the item accordingly, and producing two mouse indicators distinguished one from the other by shape, such that the processing unit can send to both computers both of said mouse indicators distinguished by shape.

### FIELD OF THE INVENTION

The present invention relates to the field of systems for providing fun and educational activities via the Internet. More particularly, the present invention relates to a public library system enabling adult and child family members located remote one from the other to perform reading together of a children literature item as selected from a library.

### BACKGROUND OF THE INVENTION

In today's style of life, there are many cases in which parents or grandparents are geographically located remote from their children or grandchildren respectively. The following are only several examples:
(a) There are many cases in which grandparents are located far from their grandchildren, as they leave in a different city, state or a country. Such a remote distance limits their ability to enjoy common activities with their grandchildren. In the AARP Grandparenting Survey of 2002, American grandparents asked for the most significant reason preventing them from seeing their grandchildren. About 45% of the grandparents answered that the reason is that they live too far away from their grandchildren. Furthermore, about 45% answered that the farthest of their grandchild lives more than 200 miles away from them;
(b) There are relatively many cases of divorced parents, a situation which enforces a geographic separation between a parent and his children;
(c) There are also many cases in which a parent leaves his home for days or weeks for business purposes, army service (for example, 500,000 American soldiers have children), therefore being remote from his children for days or weeks;
(d) One or two of the parents stays long and late hours at work, missing the added value of performing quality, educational, and frequent common activities with their children.

Hereinafter, for the purpose of this invention a parent or a grandparent will be referred to herein as “adult”. A child, whether it is a son, daughter, grandson, or granddaughter will be referred to as “child”. Generally, the present invention is most suitable for adult-young children, up to the age of 10 years old. In most of the abovementioned cases, the ability of the adult to enjoy a common activity with the child limited to a short conversation over the phone. In the recent years, when the broadband Internet has become widespread, the discussion between remote child and adult can be associated with a live video enabling each party to speak and view the other party. While the video channel (hereinafter, the term “video”, or “video channel” refers to a communication channel which transfers both sound and image) increases the effect of the communication, the interaction is still limited to a relatively casual and short discussion, as there are no many subjects that can form a common denominator for discussion between a young child and a grandparent or parent in view of the large difference of age.

The development of the Internet has introduced various activities that form a basis for interaction between two remote parties. For example, there are many games that can be played between two remote parties via the Internet. However, these games are in many cases not so suitable for play between remote adult and young child, in view of their different capabilities, and subject of interest. Moreover, naturally the playing of such a game does not necessarily contribute to the feeling of closeness between an adult and child, as when a typical game is played there is no association of a live video channel showing the two remote parties.

One educational, attractive, family oriented activity (even between family members of different generations) which is commonly performed between an adult and a young child is the reading together of children literature, for example, a children book. This kind of activity is generally longer in duration, may result in a casual discussion, generally creates deep and meaningful interactions, raises the feeling of closeness, brings the added value to both the adult and child, and gives a lot of joy and satisfaction. The reading together (the term “reading together” refers herein also to the case where the adult reads the text, while the child only listens, while viewing the book pictures or a child reading to a parent, thus exercising his reading skills) can provide a substantial added value for the interaction between an adult and a child. In said AARP Grandparenting Survey of 2002, 75% of the grandparents who had activities with their grandchildren in the last 6 months indicated the reading to them or with them as one of the activities.

However, the Internet, although being developed in many respects for the remote communication between two sites, has not yet provided a platform for an electronic public library for establishing reading together of children literature by two remote parties (such as a grandfather and a grandchild). Lacking of such platform, the interaction between an adult and child that are remotely located is limited.

Some Internet sites, for example UBIBOOKS.COM, provide the option to download a selected electronic children book to a local computer. In essence, this site is a library of electronic children books, in which a user can select an item, and download it into his computer. Upon completion of the download into the local computer, an adult and child can read together while viewing the same local computer screen. There is no known children library mechanism for enabling a synchronized, reading together of a children literature item, at two remote computers.

It is therefore an object of the present invention to provide to an electronic children literature library a platform for enabling reading together of a literature item by adult and child parties that are located remote one from the other and from the library itself. The platform also provides at least an audio channel between the two parties, and preferably also a live video channel displaying and sounding to each reading party the other party.

It is still another object of the present invention to include in said library platform a synchronizing unit, which synchronizes the display at the adult and child computers.

It is still another object of the invention to include animation features within the activated literature item, which are also synchronized between the computers of the reading parties.

It is still another object of the invention to provide control over the activated library item from either, the child computer or from the adult computer.

It is still another embodiment of the invention to enable each party to follow the mouse activity of the other party, as well as the mouse activity of his own mouse, while the mouse devices being distinguished one from the other in shape.

Other objects and advantageous of the present invention will become apparent as the description proceeds.

### SUMMARY OF THE INVENTION

The present invention relates to an electronic public library system for providing reading together of an electronic children literature item at two remote computers, comprising: (a) an adult computer and a child computer that are located remote one from the other, and are connected to the Internet; (b) two mouse pointing devices, one at each of said computers; (c) a camera and microphone at each of said computers for producing an adult live video channel and child live video channel from each of said adult and child computers respectively; and (d) a library server comprising: (d.1.) a storage for storing a collection of children literature items for selection; (d.2.) a user interface for enabling access, and selection of an item from a first of said adult or child computers; (d.3.) item processing unit for (I) establishing communication with said two computers; (II) receiving the adult and child video channels from said adult and child computers respectively; (III) activating the selected children literature item; (IV) receiving mouse locations from each of said two computers from a synchronization unit; and (V) sending synchronized images simultaneously to both of said adult and child computers, wherein the images sent to each of said two computers comprise the same literature item image at a first screen portion, mouse indicators of said two computers, distinguished by shape, and for each party, a live video display of the other party positioned at a second screen portion; and (d.5.) a synchronization unit for receiving control over the literature item from each of said computers, and mouse location from each of said computers, effecting the control over the item accordingly, and producing two mouse indicators distinguished by shape, such that the processing unit can send to both computers both of said mouse indicators distinguished by shape. Preferably, the system further comprises a user interface at the server. Preferably, the system further comprises an e-commerce module at the server.

Preferably, the control over the item is possible from each of said adult and child computers.

Preferably, the electronic literature item comprises a plurality of children book pages.

Preferably, the literature item also comprises animation, sound, and related activities.

Preferably, the display at each computer further comprises assistance data to the user.

### BRIEF DESCRIPTION OF THE DRAWINGS

FIG. 1 shows the general structure of the system of the invention, which comprises an electronic library for carrying out reading together by two remote parties, according to one embodiment of the invention; and

FIGS. 2a and 2b show a page of the literature item, as appearing on the screens of the adult and child respectively, together with a live video display, according to an embodiment of the present invention;

### DETAILED DESCRIPTION OF PREFERRED EMBODIMENTS

As said, today's lifestyle involves many cases in which there is a geographic separation between grandparents and grandchildren, or between parents and their children. Such a geographic separation exhibits a significant problem to both sides, preventing them from performing many family activities that would otherwise be possible. One of such activities is the reading together of children literature.

The absence of such family activities reduces important one to one interactions and contacts that are key elements for creating strong and healthy personal relations between family members of different generations. Such absence of common activities between different-generation family members may lead to weakening of the family structure, and may create growing frustrations within the family members.

The need, desire, and demand to establish and maintain strong connections by such common and meaningful activities exist, and usually strengthen when family members of different generations (such as grandparents and grandchildren) are physically far one from the other.

Missing such inter-generation activities eliminates the capabilities of the children from benefiting from the wisdom, knowledge and love that adults, especially grandparents can bring to their grandchildren.

As said, an object of the present invention is to provide a system enabling an electronic children literature public library to provide adult and child parties remote one from the other to perform a synchronized reading-together activity,

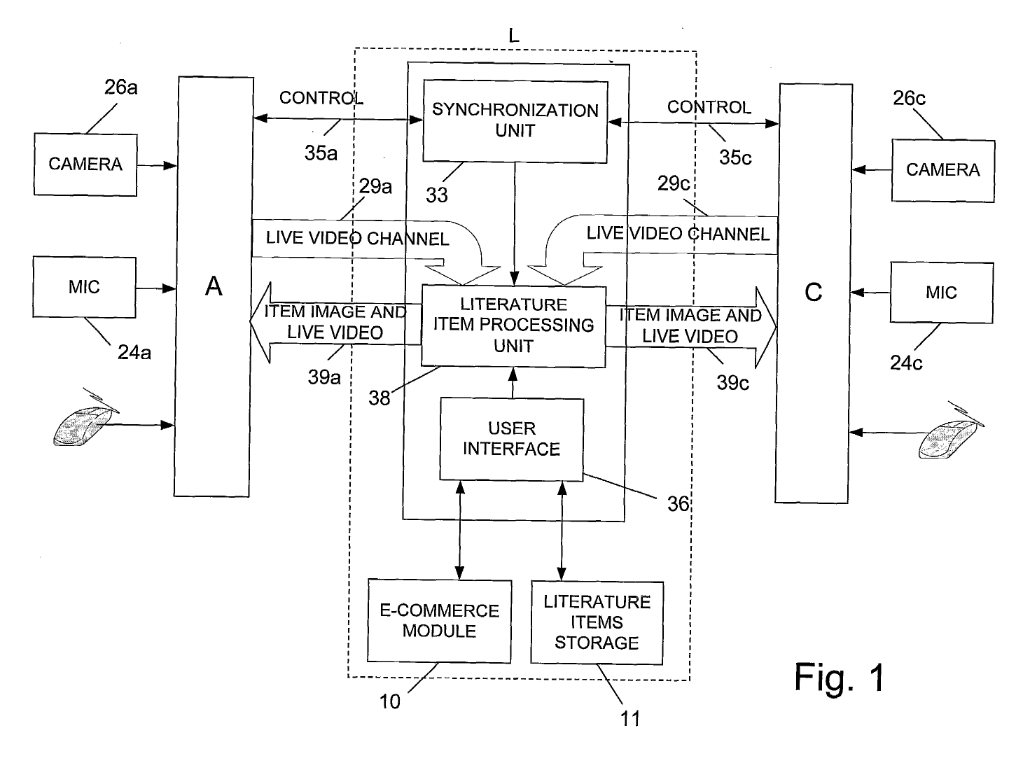

FIG. 1 shows a system according to an embodiment of the present invention. The system mainly comprises an adult computer A, a child computer C, and an electronic library server L having storage 11 of children literature items. These three entities, A, C, and L are remotely located one from the other, and are connected to the Internet.

The library server L mainly comprises an e-commerce module 10, literature items storage 11, user interface 36, synchronization unit 33, and literature item processing unit 38. The literature items storage 11 comprises a collection of children literature items, for selection. As such literature items are generally copyrighted, arrangements for using the items are made beforehand between the items owners and the library server operator.

In order to initiate the reading activity, a first party, which may be either the child at the child computer C (or the child's parent, if the child is too young) or the adult at the adult computer A initiates contact with the library server L via user interface 36. He is first referred to the storage 11, selects an electronic book item for the reading together, and then he is directed to schedule an online meeting with the other party—while in this step the first party provides the address of the other participating (i.e., second) party. Upon scheduling, an invitation is sent to the computer of the second party. Then, said first party is directed to the e-commerce module 10, to arrange payment, and identification, etc. (if necessary). The library server L then contacts the computer of the second party. Upon confirmation of the session by the second party, the library server L, by means of the literature item processing unit 38 initiates a simultaneous display of the first page of the item on the screens of both the child and adult computers A and C respectively. From this moment, the display is synchronized at said two computers (i.e., a same page of the item appears always on the screens of both computers). Furthermore, the processing unit 38 receives live video channels (or in some cases, although less preferable only sound) 29a and 29c from each of said parties A and C, and associates the live video with the images of the item that are sent over combined image-video channels 39a and 39c to computers C and A respectively, enabling each party to hear and view the other party (assuming both sides have at least a microphone 24a 24c, and preferably also a camera 26a, 26c). The live video is displayed on a portion (generally small partition) of the parties screen, and the item images are displayed at another portion of the screen. Furthermore, the library server sends and shows on the screen of each party two mouse indicators, a first mouse indicator is the indicator of the party own mouse, and the second mouse indicator is the mouse indicator of the other party. Said two displayed mouse indicators are distinguished by shape, enabling the parties to determine to which party each mouse indicator relates. Therefore, the synchronization unit 33 at the server receives over control lines 35a and 35c indications for the mouse activities and mouse location of each computer, and sends over same line to each computer the indications for the mouse activities and mouse location of the other computer. The synchronization unit 33 creates said distinguished mouse indicators, positions them at the right locations on the screens of both parties, and synchronizes the displays at both computers upon each movement. Furthermore, each signal for controlling the library item, which can be due to a mouse activity in either of said two computers, is also conveyed to the synchronization unit 33 at the library server L over lines 35a and 35c. The synchronization unit conveys the item activation signals to the processing unit 33. As said, preferably the adult and child have equal control over the item.

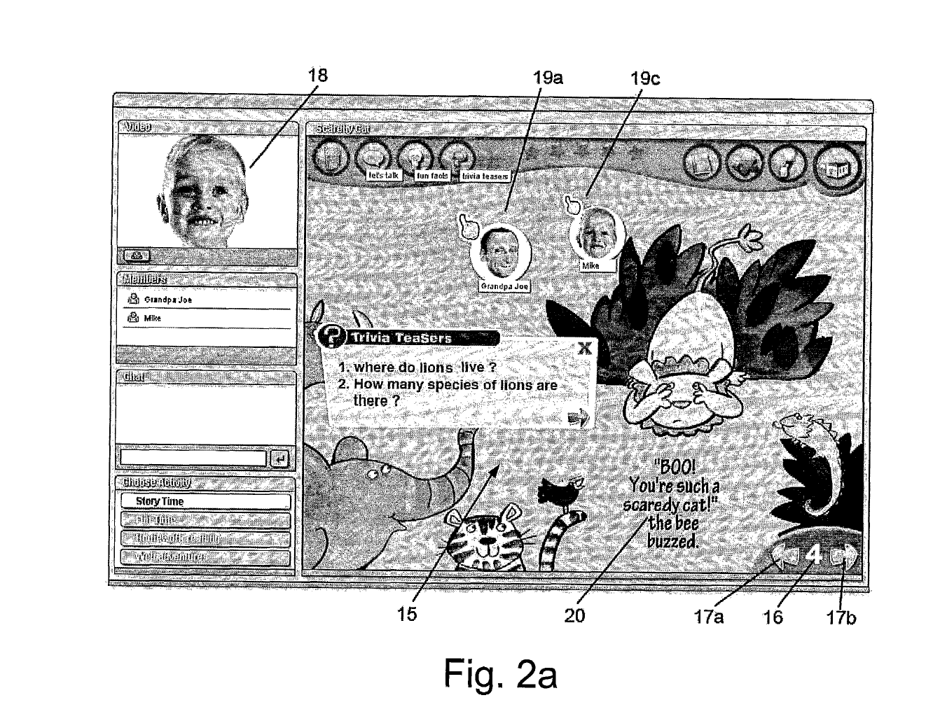

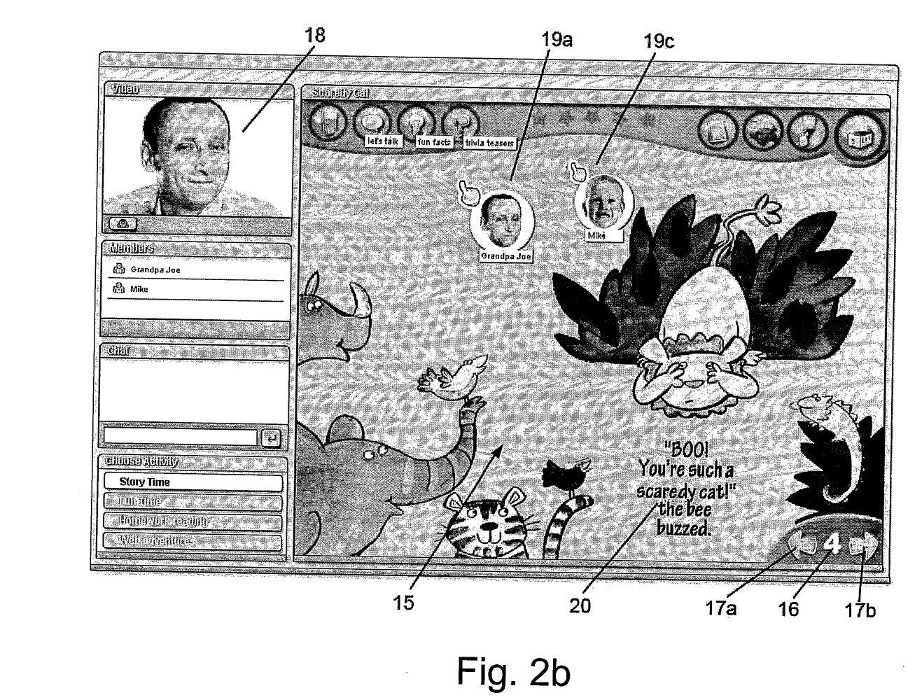

FIG. 2a shows an exemplary display at the adult (grandparent) computer A, and FIG. 2b shows an exemplary display at the child computer C according to an embodiment of the present invention. A page 15 of the activated literature item is displayed at the right side of the screen, and it generally spans most of the screen. In this case, the page includes both text 20 and pictures 21. The live video 18 showing the other party is shown at the upper-left portion of the screen. As said, the video channel also includes audio. The item page number 16 is also indicated, together with forward and backward buttons 17a and 17b respectively. As previously said, the screens of both parties are synchronized, and therefore any page or display from the item is displayed simultaneously at the two computers. The control over the portion of the item which is displayed (for example, which page of the book is displayed) is possible from either computers, but in any case, any change to the display is effected at the other party computer as well, in such a manner that both parties see the same display of the item at any given time.

Preferably, the literature item also includes various dynamic animation features and activities, as is common in the art of electronic books. However, in contrast to the prior art in which the item, and therefore the animation, are effected locally on the display of a single computer, according to the present invention the item pages, as well as any animation thereof are effected and displayed simultaneously on the screens of both parties no matter which party activated them. The animation features, which when available (their availability may be indicated by a specific mark on the screen) add an additional dimension to the excitement of the reading together.

As said, the display at each party computer preferably shows two mouse indicators, a first indicator 19a of the adult, and a second mouse indicator 19c of the child, that are differentiated by shape (or size) one from the other. For example (not shown), the mouse indicator 19a of the adult may be in a form of a face of an older person, while the mouse indicator 19c of the child may be in a form of a face of a young child. In such a manner, each party can follow also the mouse activity of the other. In such a manner, for example, when the display shows a house, the adult may say: “Dear grandson, let's see what is within the house”. Then, the child may see on his screen the adult mouse indicator 19 moves toward the house, activating the animation associated with it, and showing the house interior. The activation of the animation may be involved by a simultaneous sound of both the parties (the child and/or the adult), as well as the sound associated with the item animation.

The system of the present invention should not introduce infringement of copyrights by displaying simultaneously the item on two displays. This issue should be resolved by proper arrangements between the library server L operator, and the items copyright owners.

It should be noted that the system of the invention may easily be adapted to provide reading-together of a children library electronic literature item in more than two locations. This can be done in a manner similar to the manner as described above. This option will not be discussed in detail for the sake of brevity.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. An electronic public library system for providing reading together of an electronic children literature item at two remote computers, comprising:
An adult computer and a child computer that are located remote one from the other, and are connected to the Internet;
Two mouse pointing devices, one at each of said computers;
A camera and microphone at each of said computers for producing an adult live video channel and child live video channel from each of said adult and child computers respectively; and
A library server comprising:
(a) A storage for storing a collection of children literature items for selection;
(b) A user interface for enabling access, and selection of an item from a first of said adult or child computers;
(c) Item processing unit for (I) establishing communication with said two computers; (II) receiving the adult and child video channels from said adult and child computers respectively; (III) activating the selected children literature item; (IV) receiving mouse locations from each of said two computers from a synchronization unit; (V) sending synchronized images simultaneously to both of said adult and child computers, wherein the images sent to each of said two computers comprise the same literature item image at a first screen portion, mouse indicators of said two computers distinguished one from the other by shape, and for each party, a live video display of the other party positioned at a second screen portion; and
(d) A synchronization unit for receiving control instructions over the literature item from each of said computers, and mouse location from each of said computers, effecting the control over the item accordingly, and producing two mouse indicators distinguished one from the other by shape, such that the processing unit can send to both computers both of said mouse indicators distinguished by shape.

2. System according to claim 1, further comprising a user interface at the server.

3. System according to claim 1, further comprising an e-commerce module at the server.

4. System according to claim 1, wherein the control over the item is possible from each of said adult and child computers.

5. System according to claim 1, wherein the electronic literature item comprises a plurality of children book pages.

6. System according to claim 1, wherein the literature item also comprises animation, sound, and related activities.

7. System according to claim 1, wherein the display at each computer further comprises assistance data to the user.
